(19) United States
(12) Patent Application Publication
(10) Pub. No.: US 2016/0167268 A1
(43) Pub. Date: Jun. 16, 2016

(54) METHOD AND INJECTION MOLD FOR PRODUCING AN INSERT PART HAVING A PLASTIC COLLAR

(71) Applicant: FOSTAG FORMENBAU AG, Stein am Rhein (CH)

(72) Inventor: Rolf MÜHLEMANN, Schlattingen (CH)

(21) Appl. No.: 14/902,778

(22) PCT Filed: Jun. 26, 2014
(86) PCT No.: PCT/EP2014/063605

§ 371 Date: Jan. 4, 2016

(30) Foreign Application Priority Data
Jul. 4, 2013 (EP) 13175103.4

(51) Int. Cl. B29C 45/14; B29C 45/26; B29C 45/37

(52) U.S. Cl. CPC B29C 45/14336; B29C 45/376; B29C 45/2602; B29K 2995/0078; B29L 2031/7132

(57) ABSTRACT

A method and an injection mold for carrying out the method. The method according to this invention allows for a collar made of plastic to be injected molded onto an insert part having a circumferential edge. According to this invention, the insert part is inserted into a receptacle cavity of an injection mold. In a first step, plastic webs directed radially outward are formed and then mobility or means of the injection mold are lowered, the bottom part of the collar is completely formed and finally, in a third injection step, a top plastic layer of the collar is formed at the top on the edge.

### BACKGROUND OF THE INVENTION

1. Field of the Invention

This invention relates to a method for producing an insert part with an edge running perpendicular to a central axis of the insert part, at which edge a collar made of plastic can be provided by an injection mold, including at least one upper and one lower plate with mobility or mobile ability.

2. Discussion of Related Art

In the case of disposable containers, such as cups or bowls, attempts are made for economic and ecological reasons to design these containers as thin-walled as possible. If these containers are designed particularly thin-walled, they exhibit only a very small dimensional stability. This dimensional stability is usually achieved by the fact that, especially in the case of cups or bowls made of plastic, the upper edge is formed thickened or flanged. If such containers are produced deep-drawn from a film material, such flanging or thickening is virtually impossible to produce.

If a hot drink is poured into a disposable plastic cup, it is difficult for the user to hold it without burning fingers of the user. Also, the dimensional stability of the cup is again or further reduced by the raised temperature.

Accordingly, disposable cups are also produced from foamed plastic, in particular from foamed polystyrene, which has a relatively high insulating effect. With these cups, on the other hand, there is one problem that these foamed cups are perceived as inconvenient by many users and in addition the edge of the cup is not extremely dimensionally stable and so small parts of the foamed material break away and are also drunk or consumed by the user. The holding strength of a lid made of another material pushed onto such a cup is also insufficient.

In the foodstuffs industry, various products are filled into bowls made of plastic. Because these products often have a tendency towards oxidation, it is not sufficient simply to push on a lid. Instead, an aluminium foil is usually pressed onto the product and a lid is then placed over the latter. Because the aluminium foil is placed slightly oversized precisely onto the food that is filling the bowl, this is not a complete seal. The plastic lid pushed onto the bowl likewise does not represent an airtight closure. Such an airtight closure could be produced with a suitably selected foil that is welded on or sealed with the cup or the bowl. However, since such bowls are very thin-walled, they are not suitable for a weld joint and other thermal seals usually cannot be produced either, because the bowls are made from a specially selected plastic with a UV radiation-blocking layer and are not thus suitable for a welded or sealing joint.

One problem as such has been known for a very long time, and suggestions have already frequently been put forward to provide such containers subsequently with a special collar, which is produced from another plastic which has a much greater strength than the material from which such disposable cups or bowls are produced. Most solutions proceed on the basis that the cup is regarded as an end product and a separate plastic part fixable on the edge of this bowl is produced, after which the two parts are then jointed together mechanically and possibly also welded or glued. A corresponding solution is known for example from French Patent Reference FR-2175094 A. Furthermore, U.S. Patent Reference US 2012/0318858 shows a paper cup, which can be pushed in a form-fit manner into a plastic part which comprises a plastic collar with a cup-shaped portion open at the lower side, wherein the cup wall comprises a plurality of grooves running approximately up to the collar in order thereby to form a holding region not lying directly adjacent to the paper cup.

Similarly, European Patent Reference EP 0453754 A2 discloses a container, in particular a drinks cup, with a container body preferably made of plastic, paper or the like, which comprises an upper circumferential edge for forming an opening, wherein a circumferential collar made of a compact material is assigned to this upper edge.

### SUMMARY OF THE INVENTION

There is believed to be no container known from the prior art that has a circumferential edge that is inserted as an insert part in an injection mold and on which a circumferential plastic collar is directly injection molded.

For technical reasons, this is relatively complex because insert parts are relatively unstable and very light due to their thin-wall nature. It is thus extremely complex to hold such an insert part in an injection mold in such a way that the edge of the container can be overmolded from all three sides.

One problem is solved by a method of the type mentioned at the outset with steps described in this specification and in the claims. This method is based on the knowledge that, during the injection process, webs are first injected at the lower part of the edge of the insert part while the cup is pressed against the upper injection molding plate, and these still plastic webs have sufficient load-bearing capacity to hold the extremely light insert part in position, even if a corresponding part of such an injection mold no longer supports the circumferential edge, and the collar can then be overmolded all round. The individual injection steps can correspondingly take place with a time overlap. It is also one object of this invention to provide an injection mold which is suitable for performing the method according to this invention. Such an injection mold is disclosed in this specification and in the claims.

When, in the present case, mention is made of an insert part, it relates to a thin-walled unstable container with a circumferential edge running at least approximately perpendicular to the central axis of this container. The insert part can be made of paper, aluminium foil, or paper or plastic, wherein it can be both a deep-drawn container made of the plastic film, as well as a container made from a correspondingly formed aluminium foil. The edges of such insert parts are typically unstable and usually relatively imprecise in terms of shape. It is one advantage of this invention that such insert parts can be formed into a precise container, which then acquires a stable edge and overall becomes a relatively stable container.

### BRIEF DESCRIPTION OF THE DRAWINGS

The appended drawing represents in cross-section one preferred embodiment of an injection mold suitable for performing the method, as well as a symbolic representation to explain the method according to the invention, wherein:

FIG. 1 shows a partial cross-section through a lower plate of an injection mold in the position before the insert part is inserted;

FIG. 2 shows the same view as FIG. 1 but with an inserted insert part;

FIG. 3 shows a situation after a first injection has been carried out;

FIG. 4 shows a mold after retraction of the supporting sleeve with the omission of the insert part;

FIG. 5 shows the situation according to FIG. 4 but with the insert part and after the second injection is carried out;

FIG. 6 shows the same view as in the preceding Figures, but after the third injection has been carried out;

FIG. 7 shows a simplified representation of the injection mold, the position during the first injection being represented here; and

FIG. 8 shows the situation in which the third injection has been carried out.

### DETAILED DESCRIPTION OF THE INVENTION

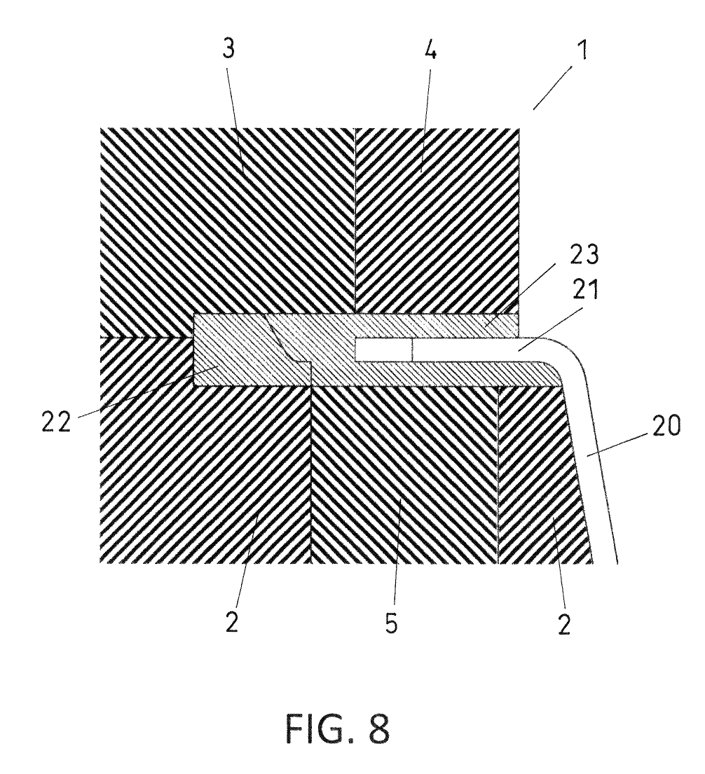

The structure of an injection mold suitable for performing the method according to this invention is first described by reference to FIGS. 7 and 8. FIGS. 7 and 8 show a simplified representation of an injection mold as a partial cross-section in the region in which an insert part is produced with a collar made of plastic. The injection mold is referred to as a whole by element reference numeral 1. It usually comprises two plates, such as a lower plate 2 and an upper plate 3. A slide 4 can be seen in upper plate 3. A slide 5 is also represented in cross-section in lower plate 2. At least one receptacle cavity 7 is present in lower plate 2, an insert part 20 being received therein. This insert part can be inserted into receptacle cavity 7 when upper plate 3 with slide 4 is raised sufficiently far. In the case of an injection mold with a single receptacle cavity, insert part 20 is inserted manually for cost reasons. In the case of larger injection molds 1 with a plurality of receptacle cavities 7, insert part 20 is inserted by a handling robot. Such devices or handling robots, with which insert parts are introduced into injection molds, are sufficiently well known, and their representation and description can accordingly be dispensed with. In this case, all the cooling channels, heating channels and injection units are also omitted, just like the various mechanical parts in order to operate the slide, or to move upper and lower plate 3, 2. In any case, only the upper plate is usually moved, while the lower plate remains stationary.

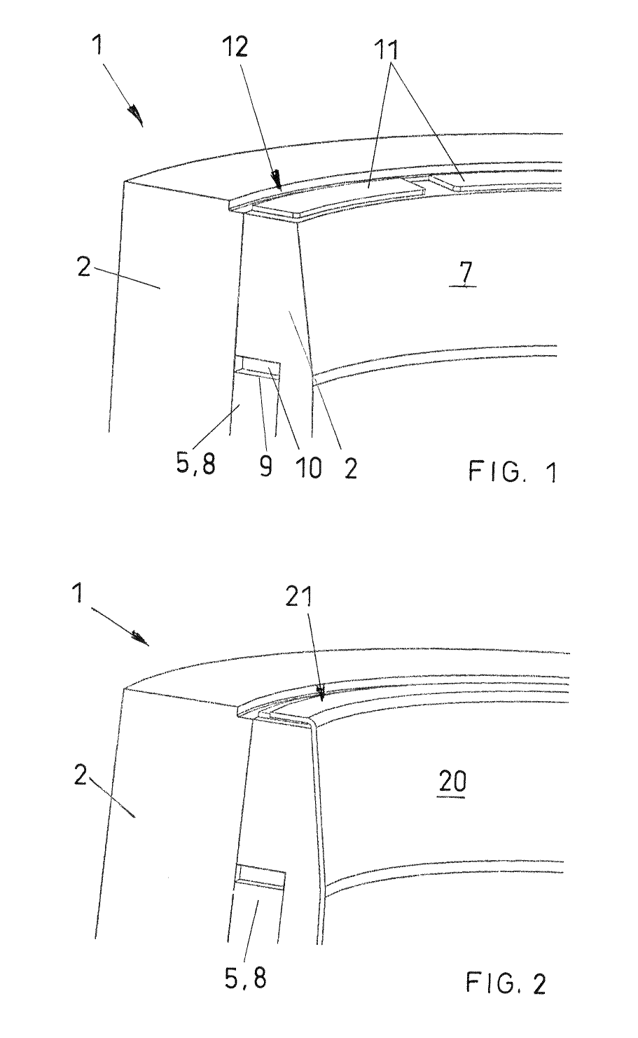

Reference is made to FIG. 1 for the explanation of the method according to this invention. FIG. 1 represents lower plate 2 on a smaller scale than in FIGS. 7 and 8, once again in a partial cross-section. Slide 5 can be seen in this cross-section, which preferably comprises a cylindrical sleeve, which is denoted by element reference numeral 8 and upper end 9 of which comprises slots, so that cylindrical sleeve 8 forms pins 10 running in an axial direction above closed end 9, the upper ends of said pins being able to be pushed out of lower plate 2. In the situation represented here, slide 5 is in its upper position in which support platelets 11, which are the upper ends of pins 10, extend out of the lower plate upwards into the receptacle cavity. Lower plate 2 of the injection mold comprises corresponding channels, in which these pins 10 can be moved in a sliding manner. Plate 2 is continuous between individual pins 10.

In the position as represented in FIG. 1, slide 5 is in an upper position. Pins 10 project with their upper ends, which form support platelets 11, out of lower plate 2, but beneath parting plane T. Parting plane T denotes the plane which forms the closing surface of injection mold 1 when lower plate 2 and upper plate 3 lie one upon the other in a sealing manner in the injection position. In this position, there remains, apart from receptacle cavity 7, a cavity 12 in which material finds space for the first injection to be carried out for the collar that is to be formed on the insert part. This cavity can clearly be seen in FIG. 1 and in. FIG. 7. Cavity 12 extends from an edge region between support platelets 11 approximately up to the inner edge of receptacle cavity 7.

FIG. 2 shows the same partial view of injection mold 1 as in FIG. 1, with insert part 20 however already lying in receptacle cavity 7 here. Peripherally outwardly formed edge 21 of insert part 20 rests, as represented here, on the edge of cavity 12 for the collar that is to be formed. When cylindrical sleeve 8 of slide 5 is in the lower position, edge 21 of insert part 20 lies on lower plate 2, if slide 5 or cylindrical sleeve 8 is located in the upper position, on support platelets 11. As soon as insert part 20 is inserted into receptacle cavity 7, injection mold 1 closes and upper and lower plate 2, 3 lie directly upon one another in parting plane T. Edge 21 is held in a clamped manner between the two slides 4, 5. Thus, slide 4 in upper plate 3 presses on edge 21, while slide 5 or support platelets 11 press edge 21 towards upper slide 4.

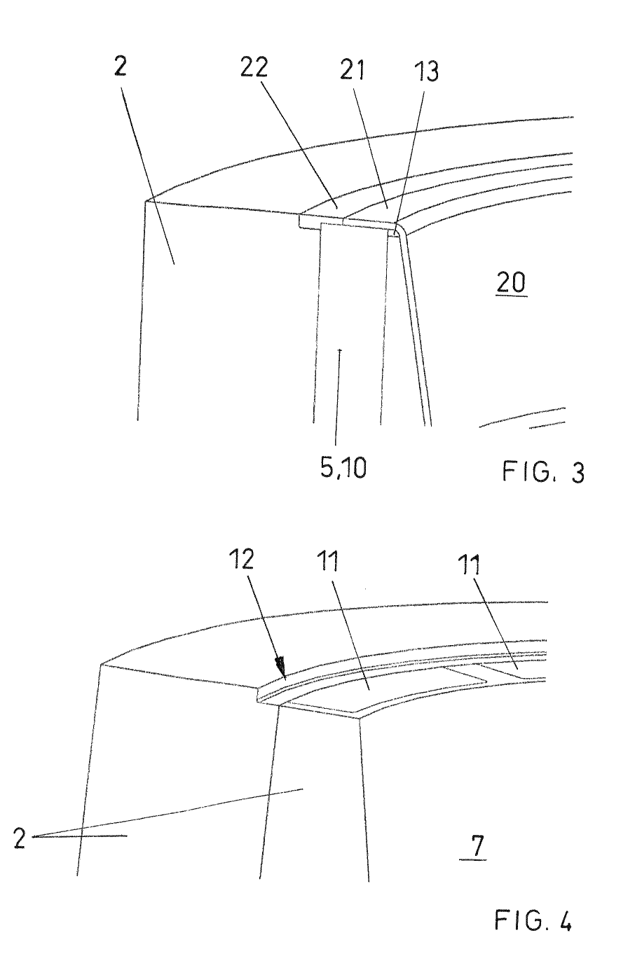

The first injection of plastic takes place in this position. A first part of the peripheral region of the circumferential collar and the webs of plastic are hereby formed, which extend from this peripheral region of collar 22 beneath edge 21 almost up to the side wall of insert part 20. This is most clearly shown in. FIG. 3, in which it can be seen that, after this first injection has been carried out, peripheral cavity 12 is already filled, as is concentric edge region 13 of cavity 12. The filled region of the webs between adjacent support platelets 11 cannot be seen in this representation, because in this view the cross-section runs through a pin 10 of the cylindrical sleeve of slide 5.

Once this first injection has been completed, slide 5 in the lower plate 2 is lowered and support platelets 11, which are in principle the upper end faces of pins 10, lie flat and flush with the upper face of lower plate 2 in the region of cavity 12. In this position represented in FIG. 4, insert part 20 is not represented for the sake of clarity and the view is correspondingly free onto receptacle cavity 7 in which insert part 20 itself would rest.

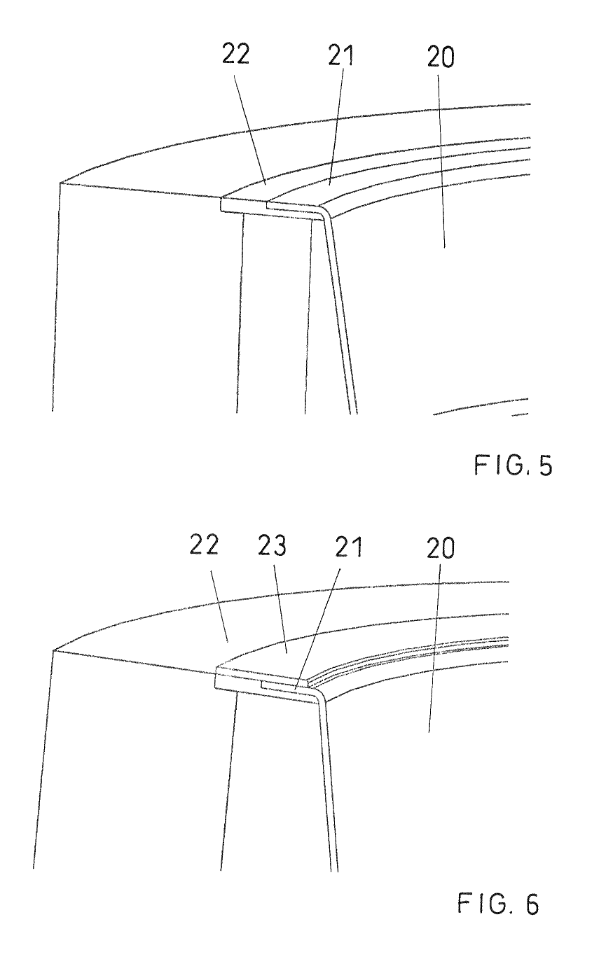

FIG. 5 represents a situation whereby the second injection is completed. As a result of the lowering of slide 5 or cylindrical sleeve 8 with pins 10, an additional space is freed that can be filled during the second injection. During this time, insert part 20, which is again represented in this FIG. 5, initially rests only on the webs formed after the first injection, whereas in the second injection the intermediate spaces between the webs, which have become free by the lowering of support platelets 11, are filled. Collar 22 that is to be formed on insert part 20 comprises, after this second injection, a completely covering area beneath edge 21 of insert part 20 and the peripheral part of collar 22, which adjoins in an adhering manner the peripheral end face of edge 21 of the insert part.

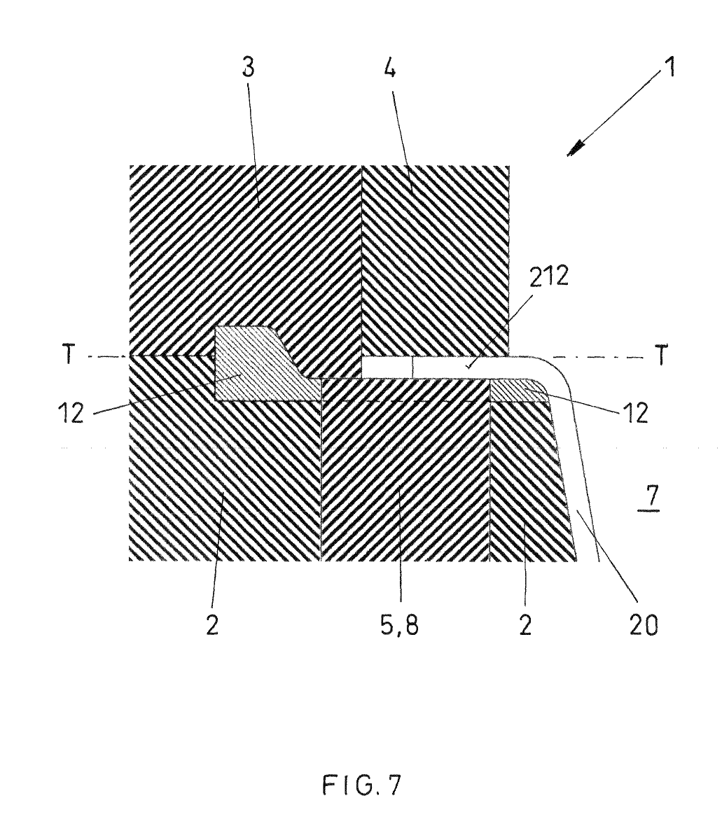

In a further step, which can be seen most clearly in FIG. 8, upper slide 4 in the upper plate 3 is also raised and peripheral collar 22 is completed with a third injection. A plastic layer 23 of collar 22 is formed in the third injection. This upper plastic layer 23 can, as represented in FIG. 6, only be a flat top layer, which covers the peripheral region of collar 22 and the part lying towards the center, and thus also edge 21 of insert part 20.

The plastic will be selected depending on the conditions that the insert part has to meet in the finished state. There is a wide variety of possible variations here. In the simplest case, the first, second and third injection will all be carried out with the same plastic. However, the first and second injection can perfectly well be carried out with the same plastic, while the third injection is carried out with a plastic differing from the latter, which for example is particularly well suited for applying a weld thereon, or a plastic can be used that has particularly elastic properties in order to achieve a form-fit connection as elastic as possible for the seal with a lid to be placed thereon. In principle, however, all three injections can be carried out with different plastics. Thus, in certain circumstances it may be advisable to carry out the second injection with a plastic which has a higher strength in the cooled and hardened state than the plastic that has been used in the first injection. This is particularly advisable if the insert part is an insert part made of particularly unstable material, such as for example paper or paperboard. The injection molded collar then endows the insert part with a much greater strength through its rigid collar, which can be produced according to the method of this invention.

Even though, for the sake of clarification, the method is described here in such a way that the individual injection steps are each completed in themselves, and then the next injection procedure takes place, these injection steps can in actual fact virtually merge into one another. This is particularly the case when two such injection steps following one another and take place with the same plastic. In particular, the second injection can already take place towards the end of the first injection. In other words, the webs between support platelets 11 are filled very quickly during the injection of the first step and very quickly achieve, thanks to suitable cooling of the injection mold, sufficient load-bearing capacity to hold the very light insert part in place. Even before the end of the first injection, support platelets 11 can already be lowered and these intermediate spaces can thus also be filled by the virtually interruption-free first and second injection.

If the third injection is carried out with the same plastic as the first and second injection, slide 4 in the upper plate can already be pulled upwards towards the end of the second injection and the third injection can be started.

If the three injections all take place with the same plastic where these injections will also be carried out by the same injection nozzles, the individual injections in this case also virtually merge into one another interruption-free. The individual steps will in this case take place primarily through the movement sequence of the two slides 4 and 5.

If the method is considered, for example, with regard to the movement sequence of the two slides 4, 5, the mold is closed after the insertion of insert part 20 into receptacle cavity 7, the two slides 4 and 5 are moved towards one another and insert part 20 is clamped in the region of its edge 21. This is followed immediately by the first injection and, after cavity 12 is partially filled, lower slide 5 is lowered and injection is continued, this now being the second injection. As soon as this second injection is for the most part completed, slide 4 in the upper plate is raised and the second injection transforms directly into the third injection.

As already mentioned, these injections merging into one another are only possible to a limited extent depending on which plastic combinations are used, or the individual steps actually have to be completed in themselves.

### LIST OF REFERENCE NUMBERS

1 injection mold
2 lower plate
3 upper plate
4 slide in upper plate
5 slide in lower plate (cylindrical sleeve)
7 receptacle cavity for insert part
8 cylindrical sleeve
9 upper end of the sleeve
10 pins
11 support platelets
12 cavity for collar to be formed
13 concentric edge region of the cavity
20 insert part
21 edge of the insert part
22 collar on the insert part
23 upper plastic layer of the collar

1. A method for producing an insert part (20) with an edge (21) running perpendicular to a central axis of the insert part (20), at the edge a collar (22) made of plastic is provided by an injection mold (1), the injection mold (1) including at least one upper plate (3) and one lower plate (2) with a mobility (4, 5), the method including the steps of:
a) inserting an insert part (20) into a receptacle cavity (7) of an injection mold (1);
b) first injection of plastic and forming radially outwardly directed plastic webs at an underside of the edge (21) of the insert part (20);
c) lowering at least one of the mobility (5), between which the plastic webs are formed until upper faces formed as support platelets (11) are flush with an underside of the formed webs, after which a second injection of plastic takes place until a circumferential collar (22) is formed on the underside of the edge (21) of the insert part (20);
d) third injection of plastic forming a top layer on top of the edge (21) of the insert part (20) for the formation of the complete collar (22) at the edge (21) of the insert part (20); and
e) ejection of the insert part (20) with the complete collar (22).

2. The method according to claim 1, wherein the first, second and third injections all take place with the same plastic.

3. The method according to claim 1, wherein the second injection starts towards a chronological end phase of the first injection.

4. The method according to claim 1, wherein the first and second injection take place with the same plastic and the third injection takes place with another plastic.

5. An injection mold (1) for producing an insert part (20) with the method according to claim 1, with an edge (21) running perpendicular to a central axis of the insert part (20), at which edge a collar (22) made of plastic is provided, comprising a lower plate (2) and an upper plate (3), the lower plate comprising one or more receptacle cavities (7), wherein each receptacle cavity (7) comprises at least one insert-part receptacle with a plane end face, and the mobility (5) are present on which, in an upper position, the insert part (6) rests with the edge (21) and the insert part (20) is able to press on a slide (4) of the upper plate (3), and in a lower position of the mobility (5) the edge (21) of the insert part (20) can be overmolded all around.

6. The injection mold according to claim 5, wherein the mobility (5) is a slide in the form of a cylindrical sleeve (8), which is mounted mobile in the lower plate (2).

7. The injection mold according to claim 6, wherein pins (10) are formed on the cylindrical sleeve (8) at an upper end (9), the ends of which pins form support platelets (11), wherein adjacent support platelets (11) are each spaced apart for the formation of plastic webs.

8. The injection mold according to claim 5, wherein there is formed in the lower plate (2), at the upper edge of each receptacle cavity (7), a cavity (12) which determines a height, a width and a shape of the collar (22) to be formed at the edge (21) of the insert part (20).

9. The injection mold according to claim 5, wherein a slide (4) is in the upper plate (2), wherein the edge (21) of the insert part (20) can be held in a clamped manner between the two slides (4, 5) while the first injection takes place.

10. The injection mold according to claim 6, wherein a displacement path of the slide (4) in the upper plate (3) corresponds to a thickness of the plastic layer of the collar (22) over the edge (21) of the insert part.

11. The injection mold according to claim 5, wherein at least one injection nozzle is provided for each different plastic to be used for the formation of the collar (22).
